(19) United States
(12) Patent Application Publication
(10) Pub. No.: US 2003/0067086 A1
(43) Pub. Date: Apr. 10, 2003

(54) Disposable tray liner for humidifiers

(75) Inventors: Patrick T. Mulvaney, Glen Allen, VA (US); Michael Garman, Stafford, VA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Hamilton Beach/Proctor-Silex, Inc.

(21) Appl. No.: 10/266,315

(22) Filed: Oct. 8, 2002

Related U.S. Application Data
(60) Provisional application No. 60/328,117, filed on Oct. 9, 2001.

(51) Int. Cl. B01F 3/04

(52) U.S. Cl. 261/107; 261/DIG. 46

(57) ABSTRACT

A disposable tray liner for a humidifier reservoir includes a bottom wall adapted for contacting a support surface of the reservoir and a continuous side wall that extends upwardly from the bottom wall. The bottom wall and continuous side wall form a water receiving receptacle that is adapted to cover the reservoir surfaces. When stale or stagnant water and mineral deposits form in the disposable tray liner, the disposable tray liner is removed from the humidifier and replaced with a new or fresh disposable tray liner. The removed disposable tray liner can be discarded or recycled

### CROSS-REFERENCE TO RELATED APPLICATIONS

This application claims the benefit of U.S. Provisional Patent Application No. 60/328,117 filed on Oct. 9, 2001, the disclosure of which is hereby incorporated by reference in its entirety.

### BACKGROUND OF THE INVENTION

This invention relates to evaporative humidifiers, and more particularly to a disposable liner for humidifier trays.

Humidifiers are often used in environments where it is desirous to raise the level of humidity, particularly in homes or the like during the winter months where the relative humidity may be reduced to an uncomfortable level by the heating system. Under these circumstances, it is beneficial to introduce moisture into the air. Humidifiers of the evaporative type are commonly used for this purpose. Such humidifiers typically include a housing with a humidifier tray or reservoir for holding water, a water absorbing material, such as a wick, partially submerged in the water, and a fan attached to the housing for creating airflow through the wick. In use, water is drawn up through the non-immersed portion of the wick by capillary action while airflow through the wick distributes the moisture from the wick to the surrounding atmosphere.

During periods of infrequent use, water in the humidifier tray may become stagnant and malodorous. Mineral deposits may be left on both the humidifier tray and wick as the water naturally evaporates. Operation of the humidifier under these conditions may cause a “musty” atmosphere as the stale water is distributed from the tray and into the room in which the humidifier is located. Thus, conventional humidifier trays require frequent cleaning and/or cycling of the water to reduce the occurrence of stale or stagnant water and mineral deposits. In one prior art system, a humidifier tray can be removed from the humidifier and cleaned in a dishwasher to remove mineral deposits and other foreign particles from the tray surface. The humidifier tray is then repositioned in the humidifier and filled with fresh water for subsequent use. However, the frequent cleaning of humidifier trays is both time consuming and labor intensive. It would therefore be desirable to provide a humidifier tray assembly that overcomes at least some of the disadvantages of the prior art.

### BRIEF SUMMARY OF THE INVENTION

In accordance with one aspect of the invention, a disposable tray liner is provided for a humidifier that has a reservoir portion with a support surface and a continuous side surface that extends upwardly from the support surface to define a water receiving cavity. The disposable tray liner comprises a bottom wall that is adapted for contacting the support surface and a continuous side wall that extends upwardly from the bottom wall. The bottom wall and continuous side wall form a water receiving receptacle that is adapted to cover the water receiving cavity of the reservoir portion.

In accordance with a further aspect of the invention, a humidifier comprises a housing having a hollow interior with an inlet end and an outlet end and a disposable tray liner that is removably connected to the housing. The disposable tray liner has a bottom wall and a continuous side wall that extends upwardly from the bottom wall to thereby form a water receiving receptacle. The humidifier further comprises a wick that extends upwardly from the disposable tray liner and into the hollow interior, and a blower assembly that is positioned for drawing, i.e. pulling and/or pushing, air into the inlet end, through the wick and out of the outlet end.

### BRIEF DESCRIPTION OF THE SEVERAL VIEWS OF THE DRAWINGS

The present invention will hereinafter be described in conjunction with the appended drawing figures, wherein like numerals denote like elements, and:

FIG. 1 is a cross sectional schematic view of a humidifier in accordance with the present invention;

FIG. 2 is an exploded front isometric view of a humidifier tray assembly with a humidifier tray and a disposable tray liner for insertion into the humidifier tray in accordance with a first preferred embodiment of the present invention;

FIG. 3 is a top plan view of the disposable tray liner of FIG. 2;

FIG. 4 is a bottom plan view of the disposable tray liner of FIG. 2;

FIG. 5 is a front elevational view of the disposable tray liner of FIG. 2;

FIG. 6 is a rear elevation view of the disposable tray liner of FIG. 2;

FIG. 7 is a left-side elevation view of the disposable tray liner of FIG. 2;

FIG. 8 is a right-side elevation view of the disposable tray liner of FIG. 2;

FIG. 9 is rear isometric view of a humidifier tray assembly in accordance with a second preferred embodiment of the present invention;

FIG. 10 is an exploded rear isometric view of the humidifier tray assembly of FIG. 9; and

FIG. 11 is a rear isometric view of the humidifier tray assembly of FIG. 9 with the disposable humidifier tray in an inverse position, showing correspondence between features of the humidifier tray and the disposable tray liner.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the disposable tray liner and designated parts thereof. The terminology includes the words above specifically mentioned, derivatives thereof and words of similar import.

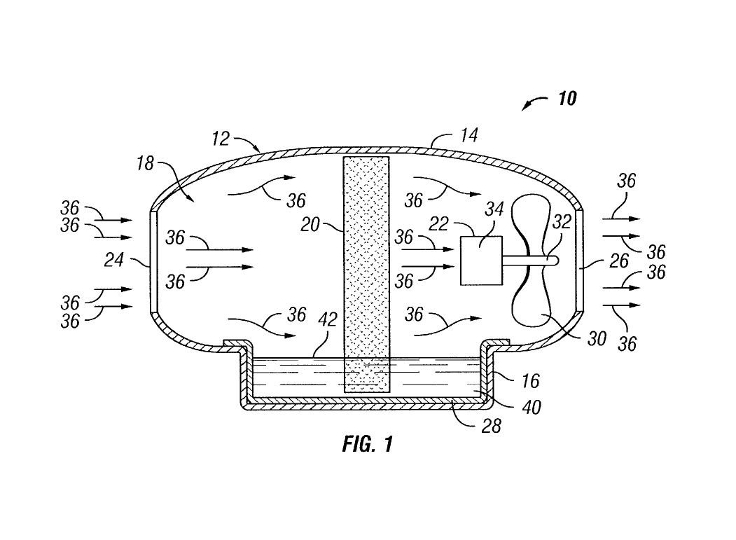

Referring now to the drawings, and to FIG. 1 in particular, a humidifier 10 in accordance with the present invention includes a housing 12 with an upper evaporative portion 14 having an inlet end 24 and an outlet end 26, and a lower reservoir portion 16 that together form a hollow interior 18 in which a wick 20, a blower assembly 22, and a disposable tray liner 28 are positioned.

The blower assembly 22 may be of conventional construction with a fan 30 mounted to a shaft 32 of an electric motor 34. The blower assembly 22 can be positioned near the outlet end 26 for drawing air through the wick 20 from the inlet end 24, as represented by arrows 36. In a further embodiment, the blower assembly 22 can be positioned near the inlet end 24 for pushing air through the wick 20 toward the outlet end 26.

The upper evaporative portion 12 and the lower reservoir portion 14 can be detachable or otherwise configured to gain access to the disposable tray liner 28. A quantity of water 40 may be located in the disposable tray liner 28, with a lower end of the wick 20 positioned in the disposable tray liner 28 for absorbing the water 40 and dispersing it over the length of the wick above a level 42 of the water.

During typical operation, dry environmental air enters the humidifier housing 12 through the inlet end 24 and continues through the hollow interior 18 and the wick 20. As air passes through the wet wick 20, the dry entrance air absorbs water from the wick 20, which in turn raises the relative humidity of the air. The humid air continues through the hollow interior 18 and is then exhausted through the outlet end 26 into the room air.

Humidifiers generally make use of a liquid level switch (not shown) which de-energizes the blower assembly 22 when the water level 42 in the lower reservoir portion 16 descends to a predetermined level. The predetermined level generally occurs well before all of the water in the reservoir portion 16 is evaporated from the humidifier 10 and leads to a situation where water stagnates in the reservoir portion 16. The stagnant condition is unfavorable for end users of the humidifier. Upon refilling the water reservoir and subsequently operating the humidifier 10, the stale or stagnant water and mineral deposits in the damp reservoir portion 16 may be dispersed into the humidified air released from the humidifier 10.

Prior to the present invention, the reservoir portion 16 was removed from the humidifier 10 and vigorously cleaned by the user to remove stale or stagnant water and mineral deposits. The inclusion of the disposable tray liner 28 in the reservoir portion 16 permits a user to remove a used liner, which may be contaminated with stale or stagnant water and mineral deposits due to inactivity of the water that is pooled in the liner, and replace it with a fresh liner 28. The disposable nature of the tray liner 28 eliminates the cleaning cycle required for a conventional reservoir portion 16. The avoidance of stagnant water conditions reduces the possibility that stale or stagnant water and mineral deposits will be released from the humidifier 10 and subsequently into a room. The present invention permits the disposal or recycling of the disposable tray liner 28, and thus is preferably durable enough to survive a plurality of water fill and operation cycles. It is preferred that a user remove and replace the disposable tray liner 28 following a period of time when stagnant water is present in the humidifier 10.

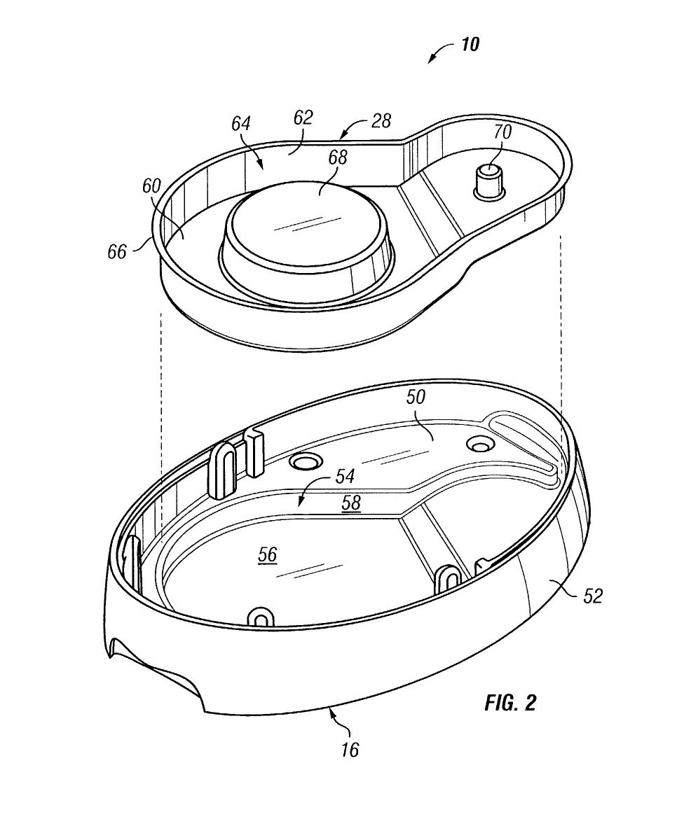

As shown in FIG. 2, the lower reservoir portion 16 includes a bottom wall 50 and a continuous side wall 52 that extends generally upwardly from the bottom wall. A cavity 54 is formed in the bottom wall 50 and includes a contoured support surface 56 and a continuous side surface 58 that extends generally upwardly from the contoured support surface.

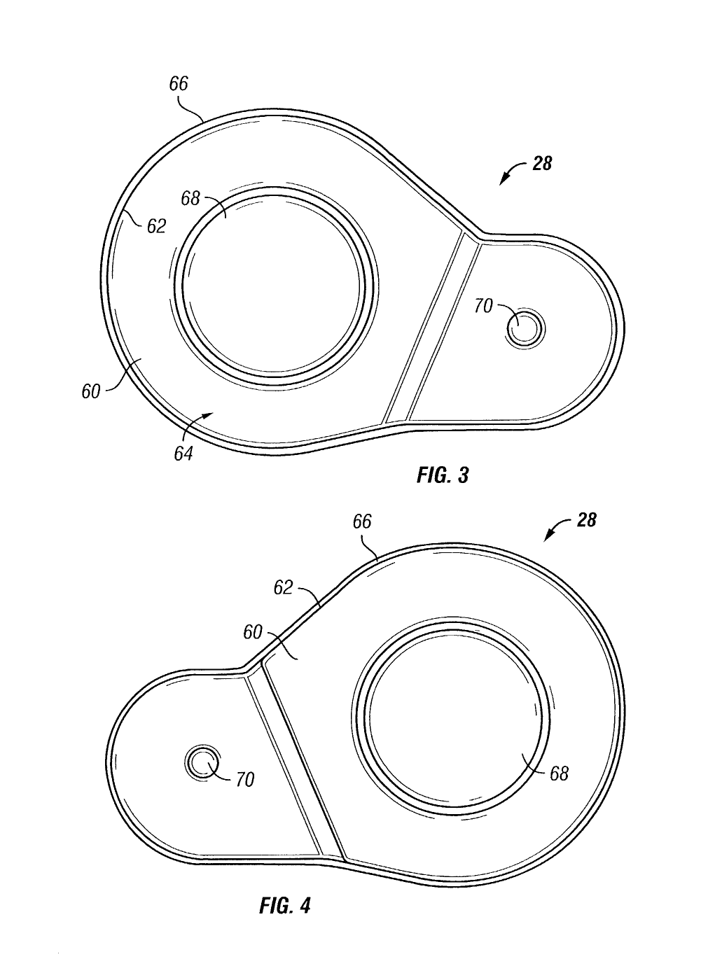

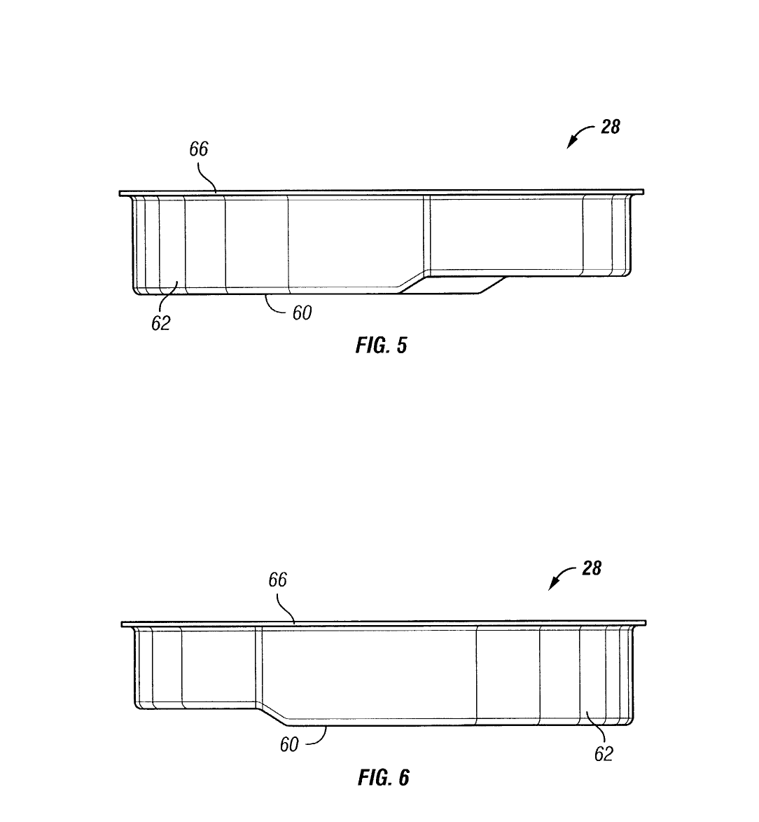

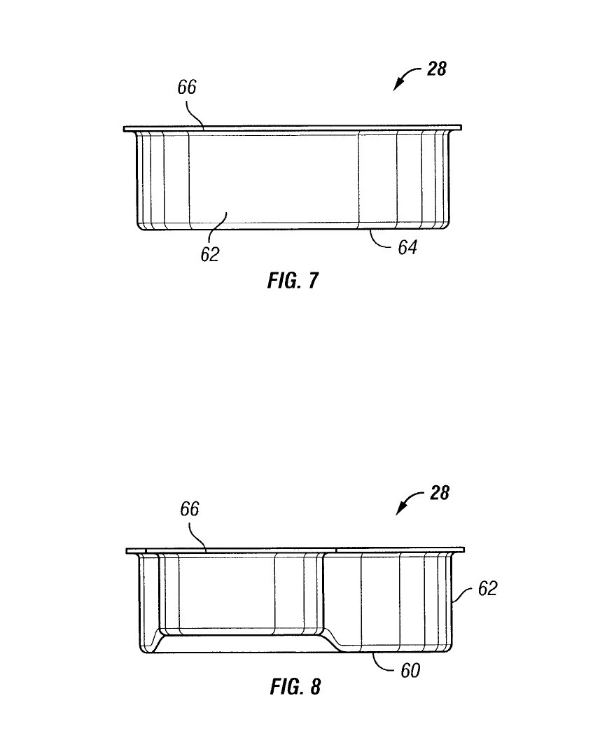

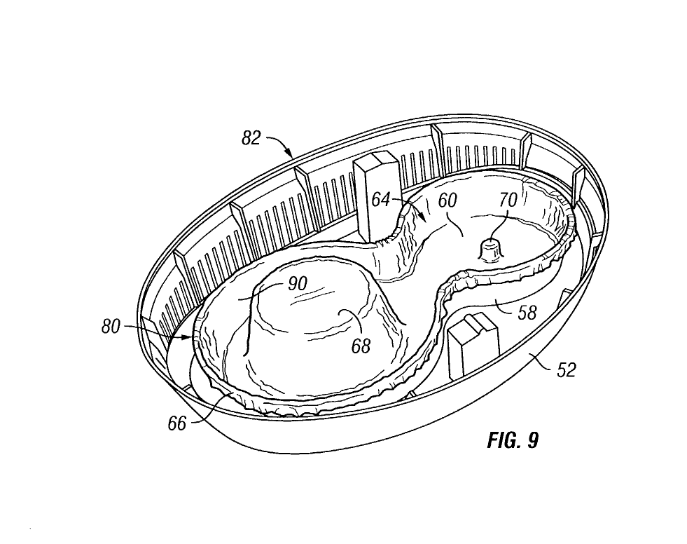

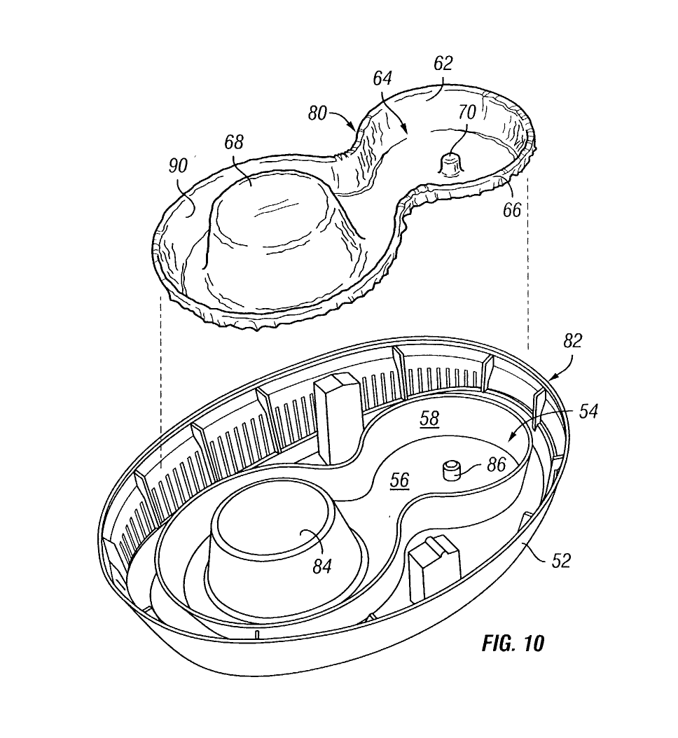

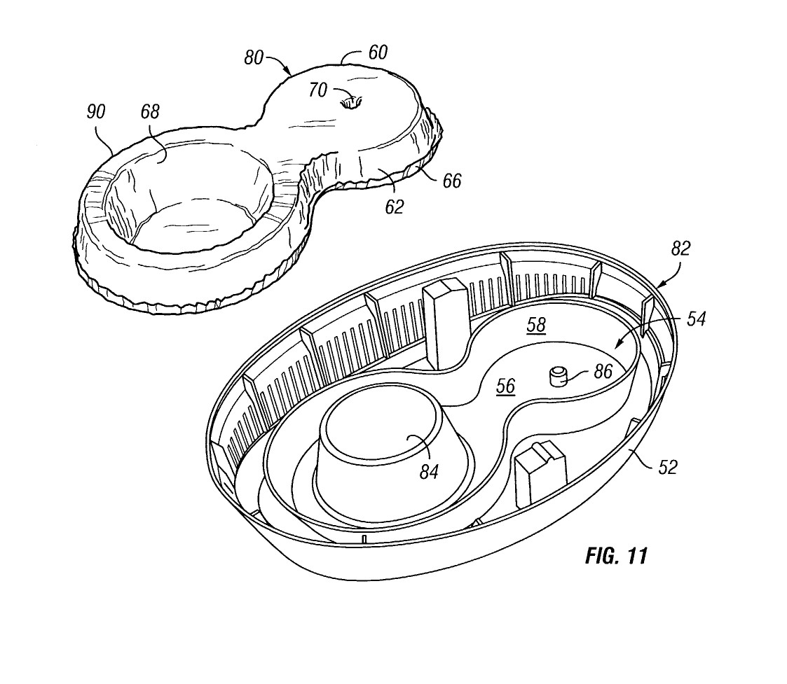

Referring now to FIGS. 2-8, the disposable tray liner 28 in accordance with a first embodiment of the invention comprises a bottom wall 60 and a continuous side wall 62 that extends generally upwardly from the bottom wall 60 to form an open receptacle 64 into which water can be received and held. A peripheral lip 66 extends generally outwardly from an upper end of the side wall 62 and serves to strengthen the disposable tray liner. Preferably, the bottom wall 60 and side wall 62 are shaped to conform to the shape of the contoured support surface 56 and continuous side surface, respectively, of the cavity 54. The disposable tray liner 28 preferably fully covers the surfaces of the cavity 54, which would otherwise be exposed to water. The bottom wall 60 of the tray liner 28 contacts the contoured support surface 56 of the cavity 54 to support a quantity of water placed in the disposable tray liner 28. To increase the usable volume of the tray liner 28, the continuous side wall 62 can extend upwardly beyond the continuous side surface 58 of the cavity 54. Hollow protrusions 68 and 70 can be formed in the bottom wall 60 of the tray liner 28 for accommodating lower reservoir portions of different configurations, such as the lower reservoir portion 82 (FIGS. 9-11) that has corresponding projections 84 and 86 extending from the contoured support surface 56 of the cavity 54.

The disposable tray liner 28 can be vacuum-formed into the shape depicted in FIGS. 2-8 using recyclable Polyethylene Terephthalate (PETE). However, it is understood by those of ordinary skill in the art that the present invention is not limited to a particular shape, material or manufacturing process. For example, the disposable tray liner 28 may be constructed of molded polymeric material, formed coated paper, flexible water impermeable sheet, or formed Aluminum. The disposable tray liner 28 may take any shape which permits the retention of a volume of water 40 near a base of a humidifier 10 and the insertion of a wick 20 into the volume of water disposed in the liner 28, and is therefore not necessarily limited to the shape of the cavity 54.

With reference to FIGS. 1 and 2, in use, the disposable tray liner 28 is inserted into the cavity 54 in the lower reservoir portion 16 to completely cover all surfaces of the lower reservoir portion 16 that would otherwise be exposed to water 40. The open receptacle 64 is then filled with water 40 to any level 42 below the peripheral lip 66.

Referring now to FIGS. 9-11, a disposable tray liner 80 in accordance with a second embodiment of the invention is illustrated, wherein like parts in the previous embodiment are represented by like numerals. The disposable tray liner 80 is constructed of a water impermeable flexible sheet 90. The flexible sheet 90 is positioned over the cavity 54 and is pressed into the cavity 54 either by molding the flexible sheet 90 by hand or by pouring water into the cavity 54 and over the flexible sheet 90. In this manner, the flexible sheet 90 completely covers the surfaces 56 and 58 of the cavity 54. By isolating the surfaces 56 and 58 of the cavity 54 with the flexible sheet 90, the cavity 54 remains dry. The disposable tray liner 80 of the second preferred embodiment may be constructed of aluminum sheet material. However, one skilled in the art will realize that the disposable tray liner 80 is not limited to constructions comprising aluminum sheet materials. The disposable tray liner 80 may be constructed of, but not limited to, polymeric, metallic, coated paper, metallic foil, or the like flexible sheet materials which are able to assume the general shape of the cavity 54, are water impermeable and are durable enough to retain water in the humidifier 10 through a plurality of fill and use cycles.

In a third preferred embodiment of the invention, the disposable tray liner 28 or 80 may be configured in shape and function to replace the lower reservoir portion 16 or 82. That is, instead of lining the cavity 54 with a disposable tray liner 28 or a flexible sheet 90, the lower reservoir portion 16 or 82 may in the form of the disposable tray liner 28 or 80. In the third preferred embodiment, the disposable tray liner 28 or 80 is generally constructed of a thin recyclable or disposable material, which is relatively inexpensive and may be removed and replaced when water stagnates in the lower reservoir portion 16 or 82. Those skilled in the art will realize from the disclosure that the disposable tray liner 28 or 80 of the third preferred embodiment is not limited to constructions using thin recyclable or disposable materials. The disposable tray liner of the third preferred embodiment may be constructed of any material using any manufacturing process that produces a liner that is rigid enough to retain a volume of water, retains the general shape of the lower reservoir portion 16 or 82 and is water impermeable.

The disposable tray liner of the third embodiment is positioned under the humidifier 10 and is filled with water. When a user suspects that stagnant water or mineral deposits are present in the humidifier 10, the entire disposable tray liner is removed from the humidifier 10 and is recycled or removed. Subsequently, a new or fresh disposable tray liner is installed in the humidifier to replace the contaminated disposable tray liner.

It will be appreciated by those skilled in the art that changes could be made to the embodiments described above without departing from the broad inventive concept thereof. It will be understood, therefore, that this invention is not limited to the particular embodiments disclosed, but it is intended to cover modifications within the spirit and scope of the present invention as defined by the appended claims.

I/we claim:

1. A disposable tray liner for a humidifier, the humidifier having a reservoir portion with a support surface and a continuous side surface that extends upwardly from the support surface to define a water receiving cavity, the disposable tray liner comprising:
a bottom wall adapted for contacting the support surface; and
a continuous side wall extending upwardly from the bottom wall, the bottom wall and continuous side wall forming a water receiving receptacle that is adapted to cover the water receiving cavity of the reservoir portion.

2. A disposable tray liner according to claim 1, wherein the continuous side wall is greater in height than the continuous side surface such that the water receiving receptacle is greater in volume than the water receiving cavity to thereby hold a greater amount of water.

3. A disposable tray liner according to claim 2, wherein the bottom wall is complementary in shape to the support surface.

4. A disposable tray liner according to claim 3, wherein the continuous side wall is complementary in shape to the continuous side surface.

5. A disposable tray liner according to claim 4, and further comprising a peripheral lip that extends outwardly from an upper end of the continuous side wall.

6. A disposable tray liner according to claim 4, wherein the bottom wall and continuous side wall are integrally formed from a plastic material.

7. A disposable tray liner according to claim 4, wherein the bottom wall and continuous side wall are integrally formed from a sheet of flexible material.

8. A disposable tray liner according to claim 1, wherein the continuous side wall is complementary in shape to the continuous side surface.

9. A disposable tray liner according to claim 1, and further comprising a peripheral lip that extends outwardly from an upper end of the continuous side wall.

10. A disposable tray liner according to claim 1, wherein the bottom wall and continuous side wall are integrally formed from a plastic material.

11. A disposable tray liner according to claim 1, wherein the bottom wall and continuous side wall are integrally formed from a sheet of flexible material.

12. A humidifier comprising:
a housing having a hollow interior with an inlet end and an outlet end;
a disposable tray liner removably connected to the housing, the disposable tray liner having a bottom wall and a continuous side wall extending upwardly from the bottom wall to thereby form a water receiving receptacle;
a wick extending upwardly from the disposable tray liner and into the hollow interior; and
a blower assembly positioned for drawing air into the inlet end, through the wick and out of the outlet end.

13. A humidifier according to claim 12, wherein the housing comprises an upper evaporative portion and a lower reservoir portion removably connected to the upper evaporative portion, the disposable tray liner being positioned in the lower reservoir portion.

14. A humidifier according to claim 13, wherein the lower reservoir portion comprises a support surface and a continuous side surface that extends upwardly from the support surface to define a water receiving cavity.

15. A humidifier according to claim 14, wherein the continuous side wall is greater in height than the continuous side surface such that the water receiving receptacle is greater in volume than the water receiving cavity to thereby hold a greater amount of water.

16. A humidifier according to claim 14, wherein the bottom wall is complementary in shape to the support surface.

17. A humidifier according to claim 16, wherein the continuous side wall is complementary in shape to the continuous side surface.

18. A humidifier according to claim 17, wherein the bottom wall and continuous side wall are integrally formed from a sheet of flexible material that conforms to the shape of the support surface and continuous side surface.

19. A humidifier according to claim 12, and further comprising a peripheral lip that extends outwardly from an upper end of the continuous side wall.

20. A humidifier according to claim 12, wherein the bottom wall and continuous side wall are integrally formed from a plastic material.
